(19) United States
(12) Patent Application Publication
(10) Pub. No.: US 2020/0153788 A1
(43) Pub. Date: May 14, 2020

(54) INFORMATION PROCESSING DEVICE AND NON-TRANSITORY COMPUTER READABLE MEDIUM

(71) Applicant: FUJI XEROX CO., LTD., Tokyo (JP)

(72) Inventors: Tatsuyuki TANAKA, Kanagawa (JP); Chie OHARA, Kanagawa (JP)

(73) Assignee: FUJI XEROX CO., LTD., Tokyo (JP)

(21) Appl. No.: 16/390,044

(22) Filed: Apr. 22, 2019

(30) Foreign Application Priority Data
Nov. 12, 2018 (JP) 2018-212501

(51) Int. Cl. H04L 29/12

(52) U.S. Cl. CPC H04L 61/2015; H04L 61/1511

(57) ABSTRACT

An information processing device includes a processor that performs a process of acquiring a first setting value that relates to a network environment and that is previously designated by a user and storing the first setting value in a memory in response to a given instruction; and a controller that, when the processor has acquired the first setting value, performs control of acquiring a second setting value that differs from the first setting value and that relates to the network environment, and giving the processor an instruction that relates to storage of the first setting value and the second setting value in the memory.

### CROSS-REFERENCE TO RELATED APPLICATIONS

This application is based on and claims priority under 35 USC 119 from Japanese Patent Application No. 2018-212501 filed Nov. 12, 2018.

### BACKGROUND

### (i) Technical Field

The present disclosure relates to an information processing device and a non-transitory computer readable medium.

### (ii) Related Art

Hitherto, there is known a technology that automatically sets a setting value relating to network connection by which an information processing device transmits and receives information in a network environment (for example, see Japanese Unexamined Patent Application Publication No. 2006-33710). With this technology, an information processing device includes a first memory that stores a setting value designated by a user, a second memory that stores a setting value acquired from an external device by using a predetermined protocol, a first setting unit that acquires a setting value from an external device by using a predetermined protocol and storing the setting value in the second memory, a network communication unit that performs network communication in accordance with the setting value stored in the first memory if the acquisition of the setting value by the first setting unit is not used and that performs network communication in accordance with the setting value stored in the second memory if the acquisition of the setting value by the first setting unit is used, and a second setting unit that stores the setting value from the external device in the first memory if the acquisition of the setting value by the first setting unit is used. Accordingly, for example, automatic setting may be made even when a dynamic host configuration protocol (DHCP) client service provided by an operating system (OS) has limitations.

### SUMMARY

When information is transmitted and received in a network environment, for example, devices identify each other and transmit and receive information. In this case, if the network environment is changed, the setting values that are used for identifying the devices each other are requested to be changed, and the setting values are changed by the designation of the users. Such a setting value may be automatically acquired. At this time, the setting value designated by the user reflects the intension of the user. If the setting value designated by the user is replaced with the automatically acquired setting value, the setting value may not reflect the intention of the user. Moreover, when the change of the setting value designated by the user caused by the change of the network environment is not sufficient, information may not be correctly transmitted and received in the network environment with the setting value designated by the user.

Aspects of non-limiting embodiments of the present disclosure relate to an information processing device and a non-transitory computer readable medium that, if a network environment is changed, is able to set a proper setting value as compared with a case where only a setting value designated by a user is stored and the stored user setting value is used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor that performs a process of acquiring a first setting value that relates to a network environment and that is previously designated by a user and storing the first setting value in a memory in response to a given instruction; and a controller that, if the processor has acquired the first setting value, performs control of acquiring a second setting value that differs from the first setting value and that relates to the network environment, and giving the processor an instruction that relates to storage of the first setting value and the second setting value in the memory.

### BRIEF DESCRIPTION OF THE DRAWINGS

An exemplary embodiment of the present disclosure will be described in detail based on the following figures, wherein:

FIG. 1 is a block diagram illustrating an example of a configuration of a network system according to an exemplary embodiment;

FIG. 2 is a schematic diagram illustrating an example of a configuration for storing a setting value in a device according to the exemplary embodiment;

FIG. 3 is a block diagram illustrating an example of a configuration of a device according to the exemplary embodiment;

FIG. 4 is a schematic diagram about storage of setting values when information is transmitted and received between an image processing device according to the exemplary embodiment and an external device;

FIG. 5 is an image diagram illustrating an example of a setting window of setting values according to the exemplary embodiment;

FIG. 6 is an image diagram illustrating an example of a setting window of setting values according to the exemplary embodiment;

FIG. 7 is a flowchart illustrating an example of a flow of a setting value storing process that is executed by the image processing device according to the exemplary embodiment; and

FIG. 8 is a flowchart illustrating an example of a flow of a setting value operating process that is executed by the image processing device according to the exemplary embodiment.

### DETAILED DESCRIPTION

An exemplary embodiment for implementing a technology of the present disclosure is described below with reference to the drawings.

In the exemplary embodiment, an example is described in which the technology of the present disclosure is applied to a device that transmits and receives information through connection to a network.

In the following description, the same reference signs are applied to components and processes having the same operations and functions throughout all drawings, and the redundant description thereof may be occasionally omitted.

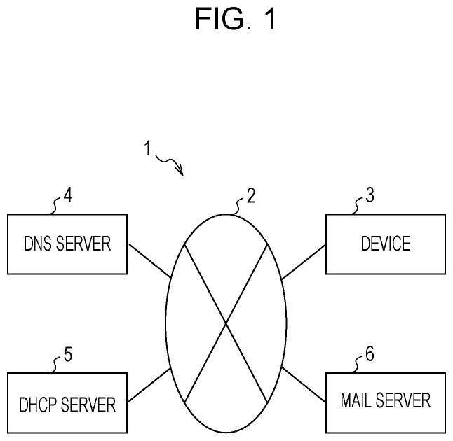

FIG. 1 illustrates an example of a configuration of a network system 1 according to the exemplary embodiment. The example illustrated in FIG. 1 schematically illustrates an example of a system that delivers an email.

In the network system 1, a device 3 is connected to a network 2, is operated in accordance with a setting value relating to a network environment, and transmits information to and receives information from an external device. To be specific, the network system 1 includes, as examples of the external device, a device 3, a domain name system (DNS) server 4, a DHCP server 5, and a mail server 6 that each are connected to the network.

Setting values are network setting information for identifying devices each other and transmitting and receiving information when information is transmitted and received in a network environment. For example, the setting values include information such as Internet protocol addresses (IP addresses) in the network environment.

The DNS server 4 is a server having installed therein a name resolution function, that is, a function including a process of performing a name resolution process of acquiring an entity such as an IP address from a name, such as a name of an electronic device like a computer or a domain name included in an email address. The DHCP server 5 is a server having installed therein a function including a process of automatically assigning network setting information including an IP address that is used when an electronic device such as a computer is connected to the network. The mail server 6 is a server having installed therein a function including a process of delivering an email.

For example, when the device 3 transmits an email, the DHCP server 5 assigns network setting information including an IP address to the device 3, the DNS server 4 performs a name resolution process by using the name or the like of the mail server, and the mail server 6 transmits the email to a target.

When information is transmitted and received in the network system 1, if the network environment is changed, a setting value that is network setting information such as an IP address is requested to be changed due to the change. Hence, the device 3 is able to change the setting value relating to the network environment.

Therefore, in the exemplary embodiment, a case of storing a setting value that allows an operation of transmitting and receiving information in the network system 1 even if the network environment is changed is described in terms of the device 3.

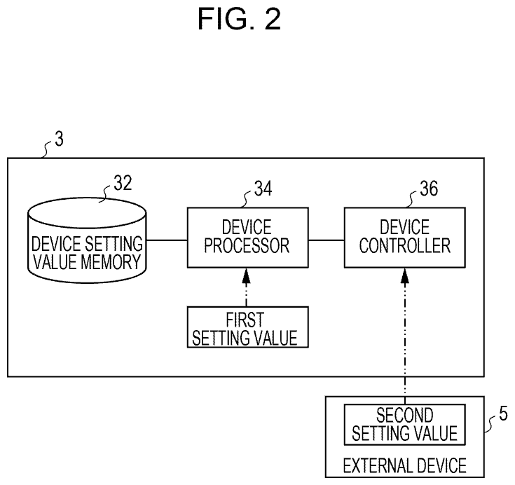

FIG. 2 is a schematic diagram illustrating an example of a configuration for storing a setting value in the device 3 in the network system 1 according to the exemplary embodiment.

The technology of the present disclosure applies to the device 3 as an example of an information processing device. To be specific, the device 3 includes a device setting value memory 32, a device processor 34, and a device controller 36.

The device setting value memory 32 is an example of a memory of the present disclosure and has a function of storing a first setting value that relates to the network environment and that is previously designated by a user. The device processor 34 is an example of a processor of the present disclosure and has a function of performing a process of acquiring the first setting value that relates to the network environment and that is previously designated by the user and storing the first setting value in the device setting value memory 32 in response to a given instruction. The device controller 36 is an example of a controller of the present disclosure. If the device processor 34 acquires the first setting value, the device controller 36 performs control of acquiring a second setting value that differs from the first setting value and that relates to the network environment, and giving the device processor 34 an instruction of storing the first setting value and the second setting value in the device setting value memory 32. The device controller 36 is able to acquire the second setting value from an external device, for example, the DHCP server 5. In this case, if the device processor 34 acquires the first setting value, the device controller 36 is able to perform control of giving the device processor 34 an instruction of storing the first setting value in the device setting value memory 32, acquiring the second setting value that differs from the first setting value and that relates to the network environment from the external device, and further giving the device processor 34 an instruction of further storing the acquired second setting value in the device setting value memory 32. Note that an instruction of storing at least one of the first setting value and the second setting value in the device setting value memory 32 is an example of an instruction relating to storage of the present disclosure. Another example may be an instruction of inhibiting at least one of the first setting value and the second setting value from being stored in the device setting value memory 32.

In this case, the device 3 may be realized by using a configuration including a computer.

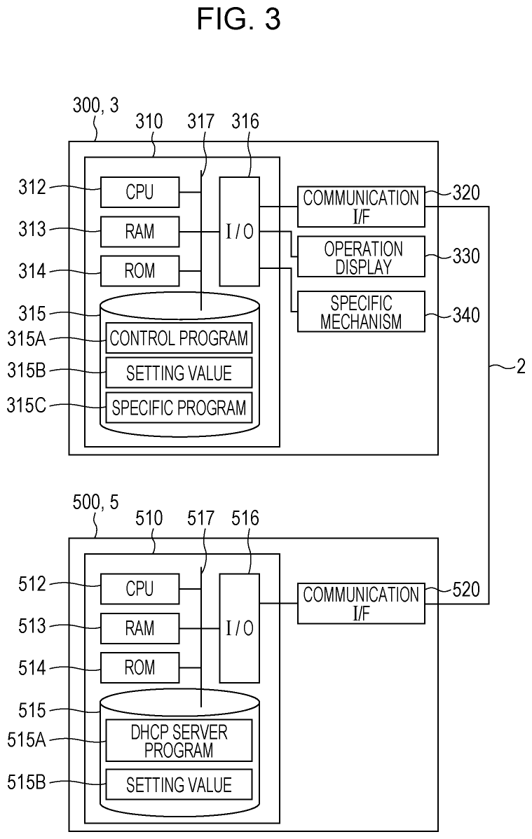

FIG. 3 illustrates a configuration example including a computer as an execution device that executes processes of realizing various functions of the device 3. In the exemplary embodiment, an example is described in which the device 3 that is an example of an information processing device of the present disclosure is applied to an image processing device such as a multifunction machine having plural functions, such as image reading and printing. FIG. 3 also illustrates a configuration example of the DHCP server 5 as an example of an external device that transmits information to and receives information from the device 3.

An image processing device 300 that functions as the device 3 illustrated in FIG. 3 includes a computer body 310. The computer body 310 includes a central processing unit (CPU) 312, a random-access memory (RAM) 313 serving as a volatile memory, a read-only memory (ROM) 314, an auxiliary memory 315 such as a hard disk drive (HDD) serving as a non-volatile memory, and an input/output interface (I/O) 316. The CPU 312, the RAM 313, the ROM 314, the auxiliary memory 315, and the I/O 316 are connected to one another via a bus 317 in a manner capable of transmitting and receiving data and commands. The I/O 316 is connected to a communication interface (I/F) 320, and an operation display 330, such as a display or a keyboard.

Moreover, the image processing device 300 has document-related functions including a copy function of copying a document, a scan function of reading (scanning) a document as an image and converting the image into data, and a print function of printing electronic data of an input document. To realize the document-related functions, the image processing device 300 includes a specific mechanism 340 including a scanner that scans a document and a printer that prints various data.

The auxiliary memory 315 stores a control program 315A for causing the image processing device 300 to function as an information processing device of the present disclosure. The CPU 312 reads the control program 315A from the auxiliary memory 315, develops the control program 315A in the RAM 313, and executes processing. Thus, the image processing device 300 that has executed the control program 315A operates as the information processing device of the present disclosure. The auxiliary memory 315 stores a setting value 315B that is network setting information including an IP address that is used when the image processing device 300 is connected to the network. The control program 315A may be provided by a storage medium such as a compact-disk read-only memory (CR-ROM).

The auxiliary memory 315 also stores a specific program 315C for realizing the document-related functions with the image processing device 300. The CPU 312 reads the specific program 315C from the auxiliary memory 315, develops the specific program 315C in the RAM 313, and executes processing. Thus, the image processing device 300 that has executed the specific program 315C operates in a manner capable of executing the document-related functions including the copy function, the scan function, and the print function.

In addition, a server 500 that is the DHCP server 5 that functions as an external device includes a computer body 510. The computer body 510 includes a CPU 512, a RAM 513, a ROM 514, an auxiliary memory 515 such as a hard disk drive (HDD), and an input/output interface (I/O) 516. The CPU 512, the RAM 513, the ROM 514, the auxiliary memory 515, and the I/O 516 are connected to one another via a bus 517 in a manner capable of transmitting and receiving data and commands. The I/O 516 is connected to a communication I/F 520.

The auxiliary memory 515 stores a DHCP server program 515A for causing the server 500 to function as the DHCP server 5. The CPU 512 reads the DHCP server program 515A from the auxiliary memory 515, develops the DHCP server program 515A in the RAM 513, and executes processing. Thus, the server 500 that has executed the DHCP server program 515A operates as the DHCP server 5. The auxiliary memory 515 stores, as network setting information including an IP address, a setting value 515B that is a second setting value of the present disclosure.

Information processing in the image processing device 300 that operates as the information processing device in the network system 1 according to the exemplary embodiment is described next.

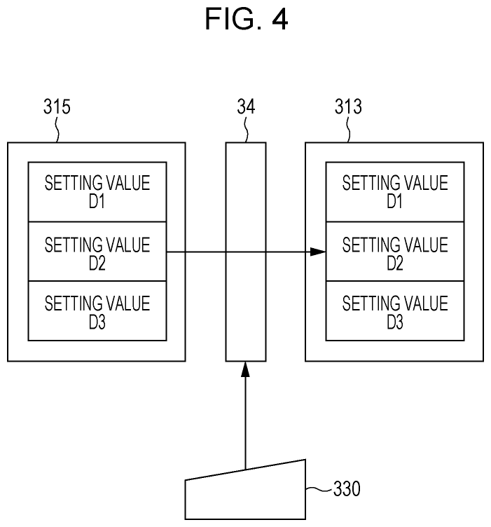

FIG. 4 is a schematic diagram about storage of setting values when information is transmitted and received between the image processing device 300 according to the exemplary embodiment and the external device via the network 2.

As illustrated in FIG. 4, when the image processing device 300 transmits information to and receives information from the external device via the network 2, for example, the image processing device 300 previously stores the IP address of the DNS server 4 as a setting value and refers to the setting value when transmitting and receiving information. To allow high-speed processing, typically, the auxiliary memory 315 that is a non-volatile memory previously stores the setting value 315B, and the device processor 34 (see FIG. 2) acquires the setting value 315B from the auxiliary memory 315 at a timing of power-on. The setting value 315B is developed in the RAM 313 and used.

In the exemplary embodiment, the auxiliary memory 315 previously has secured therein a region capable of storing IP addresses D1, D2, and D3 of three DNS servers (hereinafter, referred to as DNS server addresses). A case where the three DNS server addresses are developed in the RAM 313 is described as an example. In this case, the RAM 313 also previously has secured therein a region capable of storing the three DNS server addresses (D1, D2, and D3). In the following description, the previously secured region of the RAM 313, the region which is a predetermined region capable of storing the three DNS server addresses with the same volume is referred to as setting value memory. The setting value memory is not limited to the region secured to be able to store the three DNS server addresses with the same volume, and may be a region secured to be able to store four or more DNS server addresses. Alternatively, the setting value memory may be a region having a predetermined secured capacity.

The setting value developed in the RAM 313 may be changed by a user through an operation with the operation display 330. That is, the RAM 313 that is a volatile memory stores a setting value that is designated by a user and that reflects the intension of the user (hereinafter, referred to as user setting value).

If the network environment is changed, for example, the user setting value is changed. If the change of the user setting value caused by the change of the network environment is not sufficient, information may not be correctly transmitted and received in the network environment by using the user setting value. In addition, for example, if a setting value automatically acquired from the external device (hereinafter, referred to as automatic setting value) is used instead of the user setting value, the automatically acquired setting value may not reflect the intension of the user.

Therefore, in the exemplary embodiment, the image processing device 300 that, if the network environment is changed, is able to set a proper setting value as compared with a case where only a user setting value is stored and the stored user setting value is used. The user setting value is an example of a first setting value of the present disclosure, and the automatic setting value is an example of a second setting value of the present disclosure.

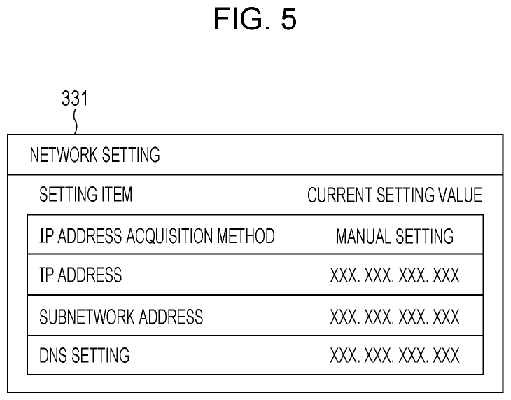

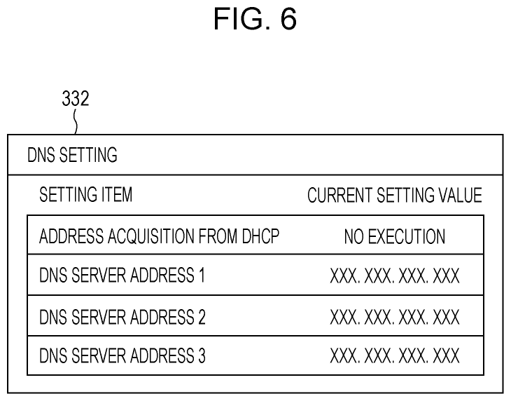

FIGS. 5 and 6 illustrate examples of setting windows of various setting values with the operation display 330 of the image processing device 300 according to the exemplary embodiment. FIG. 5 illustrates a network setting window 331 as an example of a setting window indicating types of setting values relating to the network environment. FIG. 6 illustrates a DNS setting window 332 as an example of a setting window when DNS setting is selected and instructed in the network setting window 331.

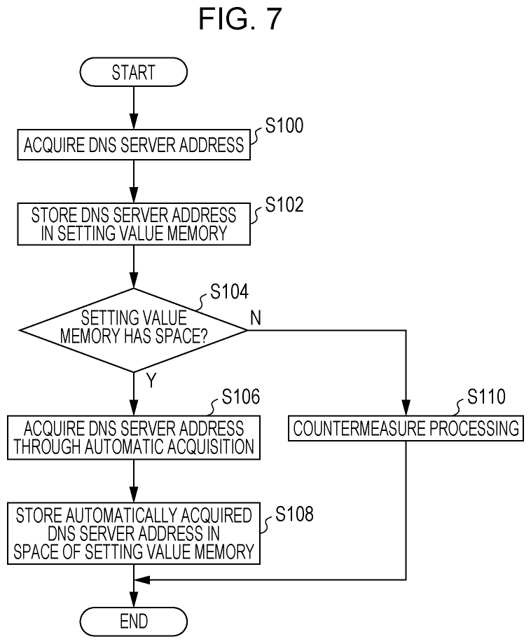

FIG. 7 is a flowchart illustrating an example of a flow of a setting value storing process according to the control program 315A that is executed by the image processing device 300.

The setting value storing process illustrated in FIG. 7, when storing a user setting value in the setting value memory previously secured in the RAM 313, attempts to perform a process of acquiring an automatic setting value and storing the acquired automatic setting value together with the user setting value. The control program 315A having written therein the setting value storing process is executed by the CPU 312 when an initial process is executed, for example, when the power of the image processing device 300 is turned on and when reboot of the image processing device 300 is instructed. In addition, in the exemplary embodiment, the DHCP server 5 distributes a DNS server address. Furthermore, in the exemplary embodiment, the example of attempting to perform the process of acquiring the automatic setting value and storing the automatic setting value together with the user setting value when storing the user setting value in the setting value memory is described. However, a process of acquiring the automatic setting value and storing the automatic setting value together with the user setting value when acquiring the user setting value may be attempted.

First, in step S100, the CPU 312 acquires a DNS server address that is a user setting value stored in the auxiliary memory 315, and in the next step S102, the CPU 312 stores the DNS server address in the setting value memory previously secured in the RAM 313. Accordingly, the image processing device 300 is able to establish a communication environment that allows communication with an external device by using the user setting value that reflects the intension of the user by referring to the setting value memory.

Then, the CPU 312 determines whether or not the setting value memory has a space in step S104. In the exemplary embodiment, the presence of a space in the setting value memory is determined on the basis of the number of DNS server addresses with the same volume. To be specific, the setting value memory according to the exemplary embodiment has a region secured in the RAM 313 in a manner capable of storing IP addresses of three DNS servers, as the setting value relating to the DNS server 4. Hence, it is determined that the setting value memory has a space if the setting value memory stores the IP addresses of less than three DNS servers. It is determined that the setting value memory does not have a space if the setting value memory is filled with the IP addresses of three DNS servers. Alternatively, it may be determined that a space is present if the space in the setting value memory is equal to or more than the volume of a single DNS server address. It may be determined that a space is not present if the space in the setting value memory is less than the volume of the single DNS server address.

When the setting value memory has a space and YES is determined in step S104, the CPU 312 automatically acquires a DNS server address in step S106. To be specific, the CPU 312 communicates with the DHCP server 5 and acquires the DNS server address. Then, the CPU 312 stores the automatically acquired DNS server address in the space of the setting value memory and ends the process routine.

As described above, if the setting value memory has a space, the automatic setting value is stored in the setting value memory previously secured in the RAM 313 together with the user setting value.

In contrast, if the setting value memory has no space and the CPU 312 determines NO in step S104, the CPU 312 shifts the process to step S110, and ends the process routine after execution of a countermeasure process. An example of the countermeasure process may be, for example, not automatically acquiring the DNS server address and inhibiting the DNS server address from being stored in the setting value memory and shifting the process to the next process, that is, ending the process routine. Another example may be a process of displaying a message on the operation display 330, the message indicating that the setting value memory has no space. The countermeasure process in step S110 may be predetermined one of the processes. The countermeasure process in step S110 is an example of a specific process of the present disclosure.

In the above description, the user setting value is stored in the setting value memory with high priority. However, a setting value selected from a setting value group including user setting values and automatic setting values may be stored in the setting value memory.

The setting value storing process illustrated in FIG. 7 is an example of a process that is executed by the information processing device of the present disclosure. The process in steps S100 and S102 is an example of a process that is executed by the processor of the present disclosure. The process from steps S104 to S110 is an example of a process that is executed by the controller of the present disclosure.

Described next is a setting value operating process to which the present disclosure is applied when a prescribed process is performed by using the user setting value and the automatic setting value stored in the setting value memory the space of which is previously secured in the RAM 313.

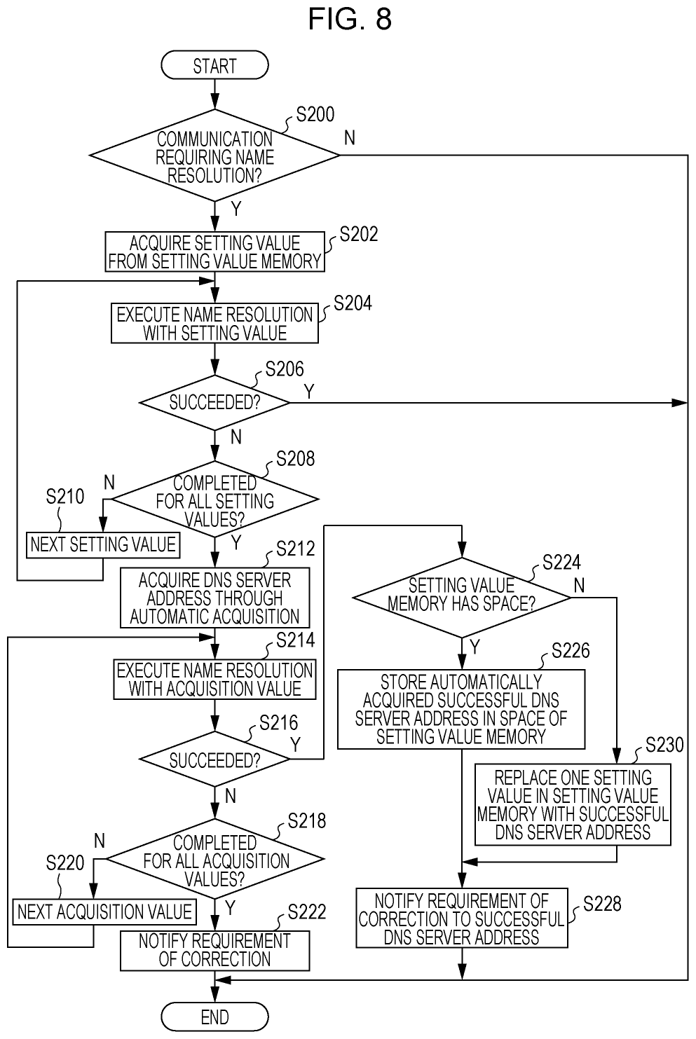

FIG. 8 illustrates an example of a flow of the setting value operating process. In the exemplary embodiment, the technology of the present disclosure is applied when communication that requires name resolution is executed such as when an email is transmitted as an example of a prescribed process.

As illustrated in FIG. 8, the CPU 312 determines whether or not execution of communication that requires name resolution has been requested in step S200. To be specific, when an email transmitting process occurs, the CPU 312 determines YES in step S200 and shifts the process to step S202. In contrast, in a case of executing a process that does not require the name resolution, the CPU 312 determines NO in step S200 and ends the process routine,

When the execution of the communication that requires the name resolution is requested (determined as YES in step S200), the CPU 312 acquires a setting value from the setting value memory previously secured in the RAM 313, and verifies the acquired setting value. To be specific, the CPU 312 acquires, in step S202, one or plural DNS server addresses that are one or plural user setting values, or one or plural user setting values and one or plural automatic setting values stored in the setting value memory.

Then, in step S204, the CPU 312 executes the name resolution process by using one DNS server address from among the setting values (the user setting values and the automatic setting values) acquired in step S202, and in the next step S206, determines whether or not the name resolution process has succeeded. For example, the CPU 312 requests the DNS server 4 of the acquired one DNS server address for a process of converting a mail server name “xxxxx.jp” into an IP address, and acquires an IP address “xxx.xxx.xxx.xxx” as the response. Thus, it is determined that the name resolution process has succeeded if the IP address has been acquired in response to the request to the DNS server 4. In contrast, it is determined that the name resolution process has failed if the IP address has not been acquired from the DNS server 4. If the CPU 312 determines that the name resolution process has succeeded, the CPU 312 determines YES in step S206, ends the process routine, and shifts the process to a process of transmitting an email or the like to execute the communication that requires the name resolution.

In contrast, if it is determined that the name resolution process has failed, the CPU 312 determines NO in step S206, and executes the name resolution process using another DNS server address. To be specific, in step S208, the CPU 312 determines whether or not the execution of the name resolution process of all acquired DNS server addresses is completed. If remaining DNS server addresses are present, the CPU 312 determines NO in step S208, and in step S210, acquires a DNS server address that is the next setting value from among the remaining DNS server addresses, and returns the process to step S204. In contrast, if the name resolution process has failed for all the DNS server addresses, the CPU 312 determines YES in step S208, and shifts the process to step S212.

In this way, the name resolution process is executed for each of the user setting values (the DNS server addresses) from the setting value memory acquired in step S202.

If YES is determined in step S208 and the name resolution process has failed with the DNS server address stored in the setting value memory, the CPU 312 acquires a DNS server address through automatic acquisition (hereinafter, referred to as automatic acquisition value) in step S212. To be specific, the CPU 312 communicates with the DHCP server 5 and acquires the DNS server address. In step S212, the CPU 312 is able to acquire one or more DNS server addresses. Then, in step S214, the CPU 312 executes the name resolution process by using the automatically acquired DNS server address. Then, in step S216, the CPU 312 determines whether or not the name resolution process has succeeded similarly to step S206.

If the name resolution process has failed, the CPU 312 determines NO in step S216. If plural DNS server addresses have been automatically acquired, the name resolution process using another DNS server address is executed. To be specific, in step S218, the CPU 312 determines whether or not the execution of the name resolution process has been completed for all the automatically acquired DNS server addresses. If the automatically acquired DNS server addresses remain, the CPU 312 determines NO in step S218, and in step S220, acquires a DNS server address that is the next setting value from among the remaining DNS server addresses, and returns the process to step S214.

In this way, when the name resolution process has failed with each of the DNS server addresses (the user setting values, or the user setting values and the automatic setting values) stored in the setting value memory, the CPU 312 further automatically acquires a DNS server address from an external device (in this case, the DHCP server), and executes the name resolution process using the automatically acquired DNS server address (the automatic setting value).

If the name resolution process has failed for all the automatically acquired DNS server addresses (the automatic acquisition values), the CPU 312 determines YES in step S218, executes a notifying process in step S222, and then ends the process routine. In step S222, a message indicating that the DNS server address is required to be corrected is displayed on the operation display 330, and notifies the user about the message. In step S222, it is desirable to display the message together with a content indicating that the name resolution has failed for each of the DNS server addresses stored in the setting value memory and each of the automatically acquired DNS server addresses.

In contrast, although the name resolution process has failed with the DNS server address stored in the setting value memory, if the name resolution process has succeeded with the DNS server address that is the automatic acquisition value (determined as YES in step S216), the CPU 312 determines whether or not the setting value memory has a space in step S224. To be specific, similarly to step S104 illustrated in FIG. 7, if the setting value memory, the space of which has been secured in the RAM 313, has stored the IP addresses of less than three DNS servers, it is determined that the setting value memory has a space capable of storing at least one DNS server address. In contrast, it is determined that the setting value memory does not have a space if the setting value memory is filled with the IP addresses of three DNS servers.

If the setting value memory has a space and YES is determined in step S224, the CPU 312 stores the DNS server address (the automatic acquisition value) with which the name resolution has succeeded, in the space of the setting value memory in step S226. Then, in step S228, the CPU 312 displays a message indicating that the DNS server address (the automatic acquisition value) with which the name resolution has succeeded is required to be corrected, on the operation display 330 to notify the user about the message, and ends the process routine.

The process in step S228 is desirable for suppressing a failure of the name resolution process next time by urging the user to correct the DNS server address stored in the auxiliary memory 315 that is a non-volatile memory to the DNS server address with which the name resolution has succeeded. That is, the setting value memory that is the RAM 313 of a volatile memory is reset in an initial process at power-off or power-on. Thus, for storage in the setting value memory that is a volatile memory at the next initial process, it is required to correct the user setting value stored in the auxiliary memory 315 that is a non-volatile memory by using the DNS server address with which the name resolution has succeeded.

In step S228, instead of notifying the user about the above-described message, a process of storing the DNS server address stored in the current setting value memory, in the auxiliary memory 315 of a non-volatile memory may be performed. In this case, the user desirably determines execution or non-execution of the process of storing the DNS server address stored in the current setting value memory, in the auxiliary memory 315 of a non-volatile memory. For example, the operation display 330 displays whether or not the DNS server address in the current setting value memory is stored in the auxiliary memory 315 as options so that the user is able to select and instruct execution or non-execution of the storing process.

In contrast, if the setting value memory has no space and NO is determined in step S224, the CPU 312 replaces at least one of the DNS server addresses stored in the setting value memory with the DNS server address with which the name resolution has succeeded in step S230, and then shifts the process to step S228. That is, storing at least the DNS server address with which the name resolution has succeeded in the setting value memory or non-execution of the storage may be displayed as options such that the user is able to select and instruct either of the options.

Accordingly, the DNS server address with which the name resolution has succeeded is stored in the setting value memory while the power of the image processing device 300 is being turned on, or until the initial process is executed.

The setting value operating process illustrated in FIG. 8 is an example of a process that is executed by the information processing device of the present disclosure. In addition, the image processing device 300 that executes the prescribed process is an example of an execution unit of the present disclosure.

For example, when the prescribed process including the name resolution process and so forth is executed, the automatic setting value may be acquired and the prescribed process may be performed if the name resolution with the user setting value has failed, and the automatic setting value may be stored in the setting value memory if the prescribed process with the automatic setting value has succeeded.

In the exemplary embodiment, the case has been described where the DNS server address is stored in the setting value memory of the predetermined region in the RAM 313; however, the present disclosure is not limited to that the DNS server address is the setting value. For example, the present disclosure may be applied to a case of storing plural setting values and performing a process by using at least one of the plural stored setting values. Examples of the plural setting values may be Windows (registered trademark) Internet Naming Service (WINS) server addresses, Session Initiation Protocol (SIP) server addresses, proxy server addresses, or Simple Mail Transfer Protocol (SMTP) server addresses.

In the above-described exemplary embodiment, the case where the exemplary embodiment is realized by the software configuration through processes using the flowchart; however, it is not limited thereto, and the exemplary embodiment may be realized by a hardware configuration.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor that performs a process of acquiring a first setting value that relates to a network environment and that is previously designated by a user and storing the first setting value in a memory in response to a given instruction; and
a controller that, if the processor has acquired the first setting value, performs control of acquiring a second setting value that differs from the first setting value and that relates to the network environment, and giving the processor an instruction that relates to storage of the first setting value and the second setting value in the memory.

2. The information processing device according to claim 1,
wherein the memory is a volatile memory, and
wherein the first setting value is previously stored in a non-volatile memory or is input to the processor by the user.

3. The information processing device according to claim 1,
wherein, if the processor has acquired the first setting value, the controller performs control of giving the processor a first instruction of storing the first setting value in the memory, and further giving the processor a second instruction relating to storage of the second setting value that differs from the first setting value and that is from an external device, in the memory.

4. The information processing device according to claim 2,
wherein, if the processor has acquired the first setting value, the controller performs control of giving the processor a first instruction of storing the first setting value in the memory, and further giving the processor a second instruction relating to storage of the second setting value that differs from the first setting value and that is from an external device, in the memory.

5. The information processing device according to claim 3,
wherein the controller performs control of giving the processor an instruction, as the second instruction, of storing the second setting value in the memory if the memory is able to store the second setting value, and performs control of executing a predetermined specific process including control of giving the processor an instruction, as the second instruction, of inhibiting the second setting value from being stored in the memory if the memory is not able to store the second setting value.

6. The information processing device according to claim 4,
wherein the controller performs control of giving the processor an instruction, as the second instruction, of storing the second setting value in the memory if the memory is able to store the second setting value, and performs control of executing a predetermined specific process including control of giving the processor an instruction, as the second instruction, of inhibiting the second setting value from being stored in the memory if the memory is not able to store the second setting value.

7. The information processing device according to claim 5,
wherein the memory is able to store a predetermined number of a plurality of the first setting values, and
wherein the controller performs control of determining that the memory is able to store the second setting value if the memory has stored a number of the first setting values, the number being smaller than the predetermined number, and determining that the memory is not able to store the second setting value if the memory has stored a number of the first setting values, the number being equal to the predetermined number.

8. The information processing device according to claim 6,
wherein the memory is able to store a predetermined number of a plurality of the first setting values, and
wherein the controller performs control of determining that the memory is able to store the second setting value if the memory has stored a number of the first setting values, the number being smaller than the predetermined number, and determining that the memory is not able to store the second setting value if the memory has stored a number of the first setting values, the number being equal to the predetermined number.

9. The information processing device according to claim 5,
wherein the memory is able to store a predetermined volume of information, and
wherein the controller performs control of determining that the memory is able to store the second setting value if the memory has a space corresponding to a capacity for storing the second setting value, and determining that the memory is not able to store the second setting value if the memory does not have the space corresponding to the capacity for storing the second setting value.

10. The information processing device according to claim 6,
wherein the memory is able to store a predetermined volume of information, and
wherein the controller performs control of determining that the memory is able to store the second setting value if the memory has a space corresponding to a capacity for storing the second setting value, and determining that the memory is not able to store the second setting value if the memory does not have the space corresponding to the capacity for storing the second setting value.

11. The information processing device according to claim 1, further comprising:
an execution unit that executes a prescribed process by using the first setting value or the second setting value stored in the memory,
wherein, if the prescribed process is not able to be executed by using the first setting value, or each of the first setting value and the second setting value stored in the memory, the controller performs control of acquiring a third setting value that relates to the network environment, executing the prescribed process by using the acquired third setting value, and executing a process corresponding to an execution result.

12. The information processing device according to claim 11,
wherein the controller performs control of giving the processor an instruction of storing the third setting value in the memory if the prescribed process has been executed by using the third setting value, and performs control of making a notification about information indicating that the prescribed process is not able to be executed if the prescribed process is not able to be executed.

13. The information processing device according to claim 11,
wherein the controller performs control of giving the processor an instruction of storing the third setting value in the memory if the prescribed process is able to be executed by using the third setting value and if the memory is able to store the third setting value, and performs control of giving the processor an instruction of replacing the third setting value with the first setting value or the second setting value stored in the memory if the memory is not able to store the third setting value.

14. The information processing device according to claim 12,
wherein the controller performs control of giving the processor an instruction of storing the third setting value in the memory if the prescribed process is able to be executed by using the third setting value and if the memory is able to store the third setting value, and performs control of giving the processor an instruction of replacing the third setting value with the first setting value or the second setting value stored in the memory if the memory is not able to store the third setting value.

15. A non-transitory computer readable medium storing a program causing a computer to execute a process for information processing, the process comprising:
performing a process of acquiring a first setting value that relates to a network environment and that is previously designated by a user and storing the first setting value in a memory in response to a given instruction; and
if the first setting value has been acquired, performing control of acquiring a second setting value that differs from the first setting value and that relates to the network environment, and giving an instruction that relates to storage of the first setting value and the second setting value in the memory.

16. An information processing device comprising:
processing means for performing a process of acquiring a first setting value that relates to a network environment and that is previously designated by a user and storing the first setting value in a memory in response to a given instruction; and
control means for, if the processing means has acquired the first setting value, performing control of acquiring a second setting value that differs from the first setting value and that relates to the network environment, and giving the processing means an instruction that relates to storage of the first setting value and the second setting value in the memory.
